(19) United States
(12) Patent Application Publication
(10) Pub. No.: US 2026/0287148 A1
(43) Pub. Date: Sep. 24, 2026

(54) LAMP

(71) Applicants: OPPLE LIGHTING CO., LTD., Shanghai (CN); SUZHOU OPPLE LIGHTING CO., LTD., Suzhou City (CN)

(72) Inventors: Haisheng LIU, Shanghai (CN); Haiqiang HU, Shanghai (CN); Chaobo LIU, Shanghai (CN); Xiaotong YANG, Shanghai (CN)

(73) Assignees: OPPLE LIGHTING CO., LTD., Shanghai (CN); SUZHOU OPPLE LIGHTING CO., LTD., Suzhou City (CN)

(21) Appl. No.: 19/686,620

(22) Filed: May 23, 2026

Related U.S. Application Data
(63) Continuation of application No. PCT/CN2024/133843, filed on Nov. 22, 2024.

(30) Foreign Application Priority Data
Nov. 23, 2023 (CN) 202311578574.2
Nov. 23, 2023 (CN) 202323178244.2

(51) Int. Cl. F21V 7/00; F21Y 105/18; F21Y 115/10

(52) U.S. Cl. CPC F21V 7/0016; F21Y 2105/18; F21Y 2115/10

(57) ABSTRACT

A lamp is provided to include a housing that including a bottom wall and a frame extending from the bottom wall in a direction away from the bottom wall, and a light outlet is formed between the bottom wall and the frame; a first light source system which is provided on the bottom wall and surrounded by the frame and has a first light exit surface at the light outlet, where the first light source system includes a first light-emitting module, and light emitted by the first light-emitting module is emergent from the first light exit surface; and a second light source system which is provided between the frame and the first light source system and surrounds the first light exit surface of the first light source system, where the second light source system extends in the light exit direction of the first light-emitting module.

This disclosure is based upon and claims the priority of PCT patent disclosure No. PCT/CN2024/133843 filed on Nov. 22, 2024, which claims priority to the Chinese patent disclosure No. 202323178244.2 filed on Nov. 23, 2023 and the Chinese patent disclosure No. 202311578574.2 filed on Nov. 23, 2023, the entire contents of which are hereby incorporated by reference herein for all purposes.

### TECHNICAL FIELD

The present disclosure relates to the field of lighting, in particular to a lamp.

### BACKGROUND

With the improvement of living standards, people have increasingly high demands for lighting in different scenarios. Among them, lamps capable of simulating natural outdoor light have gradually gained market favor and are widely used in indoor lighting for homes, office buildings, shopping malls, stadiums, stations, airports, and the like.

### SUMMARY

The present disclosure provides a lamp.

The lamp provided in this disclosure may include:
a housing, including a bottom wall and a frame extending from the bottom wall in a direction away from the bottom wall, with a light outlet formed between the bottom wall and the frame;
a first light source system, disposed on the bottom wall and surrounded by the frame, having a first light-emitting surface disposed at the light outlet, the first light source system including a first light-emitting module, and light emitted by the first light-emitting module exiting through the first light-emitting surface;
a second light source system, disposed around the first light-emitting surface of the first light source system, extending along a light emission direction of the first light-emitting module, and having a second light-emitting surface surrounding the first light-emitting surface and located on an inner side of the frame, the second light source system including a second light-emitting module, light emitted by the second light-emitting module exiting through the second light-emitting surface and emitting toward a direction away from the frame, and light emitted from the first light-emitting surface intersecting with light emitted from the second light-emitting surface.

It is to be understood that both the foregoing general description and the following detailed description are exemplary and explanatory only and are not restrictive of the present disclosure.

### BRIEF DESCRIPTION OF DRAWINGS

FIG. 1 is a perspective structural view of a lamp according to an example of the present disclosure.

FIG. 2 is a cross-sectional view of the lamp shown in FIG. 1.

FIG. 3 is an exploded structural view of the lamp shown in FIG. 1.

FIG. 4 is a schematic plan view of a first light-emitting module in the lamp shown in FIG. 3.

FIG. 5 is a schematic view of a light-emitting module in the first light-emitting module shown in FIG. 3.

FIG. 6 is a schematic view of a second light-emitting module in the lamp shown in FIG. 3.

FIG. 7 is an exploded structural view of a second light source system according to Example II of the present disclosure.

FIG. 8 is a schematic view of the second light-emitting module in FIG. 7.

FIG. 9 is an exploded structural view of a light distribution member of a second light source system according to Example III of the present disclosure.

FIG. 10 is a light path diagram when the light distribution member is a lens in the present disclosure.

FIG. 11 is a light path diagram when the light distribution member is an offset lens in the present disclosure.

FIG. 12 is a light path diagram when the light distribution member is a reflector cup in the present disclosure.

FIG. 13 is a light path diagram when the light distribution member is an eccentric reflector cup in the present disclosure.

FIG. 14 is a light path diagram of a side projection device according to an example of the present disclosure.

FIG. 15 is a perspective structural view of a projection device according to an example of the present disclosure.

FIG. 16 is an exploded structural view of the projection device shown in FIG. 15.

FIG. 17 is a lighting effect diagram of a lamp according to an example of the present disclosure.

FIG. 18 is a lighting effect diagram of a first light source system and a second light source system of a lamp according to an example of the present disclosure.

### DETAILED DESCRIPTION

To make the objectives, technical solutions, and advantages of the present disclosure clearer, the present disclosure is described in detail below with reference to the accompanying drawings and examples.

It should be noted that, to avoid obscuring the present disclosure with unnecessary details, only the structures and/or processing steps closely related to the solution of the present disclosure are shown in the drawings, and other details not closely related to the present disclosure are omitted.

In addition, it should be noted that the terms “comprise”, “include”, or any other variants thereof are intended to cover non-exclusive inclusion, so that a process, method, article, or apparatus including a series of elements not only includes those elements but also other elements not explicitly listed, or elements inherent to such process, method, article, or apparatus.

Reference Numerals used in this application may include:
100—Lamp;
200—First light source system, 201—First light-emitting surface, 210—First light-emitting module, 211—First substrate, 212—Light-emitting module, 2121—First light-emitting unit, 2122—Second light-emitting unit, 220—Diffusion structure, 240—Transparent plate, 250—Inner frame;
300—Second light source system, 301—Second light-emitting surface, 302—Non-light-emitting surface, 303—Virtual image, 304—Light/shadow transition zone, 310—Second light-emitting module, 311—Second substrate, 312—Light-emitting element, 320—Light guide assembly, 321—Light exit member, 322—Light distribution member, 3221—V-prism micro-structure, 323—Reflector, 324—Light shielding member, 325—Annular lens, 326—Prism sheet, 330—Side projection device;
400—Projection system, 410—Projection device, 420—Light-emitting assembly, 421—Aluminum substrate, 422—Lamp bead, 430—Lens module, 431—First lens, 432—Second lens, 433—Third lens, 451—First lens barrel, 452—Second lens barrel, 453—Third lens barrel, 440—Diaphragm;
500—Mounting system;
600—Housing, 610—Bottom wall, 620—Frame

Some sky lamps may consist of a light source and a patterned plate painted with blue sky and white clouds. The light source illuminates the patterned plate to form an outdoor blue sky light environment. However, this solution may not truly reproduce the matching effect of blue sky and sunlight, lacking hierarchy and stereoscopy, with poor simulation fidelity.

In response, sky lamp designs combining light sources with scattering panels have emerged on the market, forming sunlight similar to that in nature. However, the light sources are relatively single, failing to reflect changes in light, and the effect remains unsatisfactory.

In view of this, there is a need to provide a lamp that may truly simulate natural light effects.

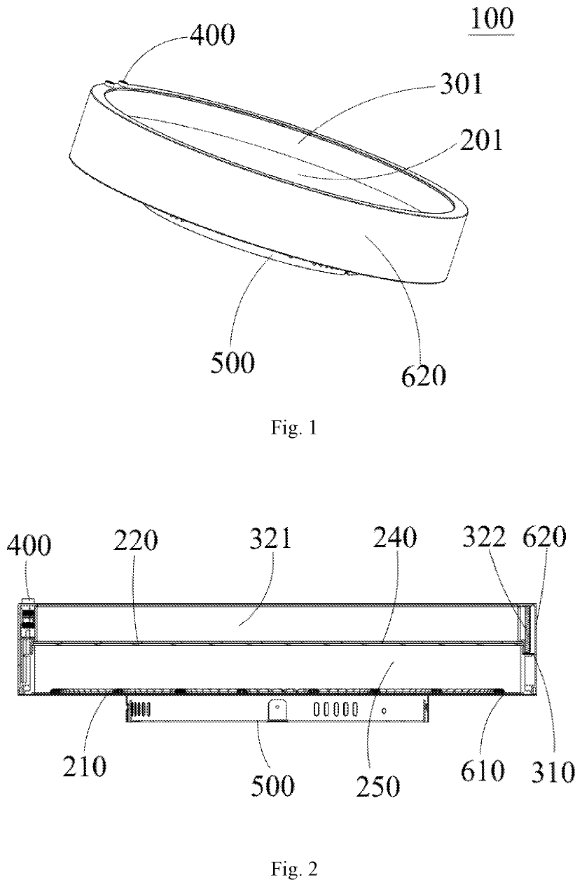

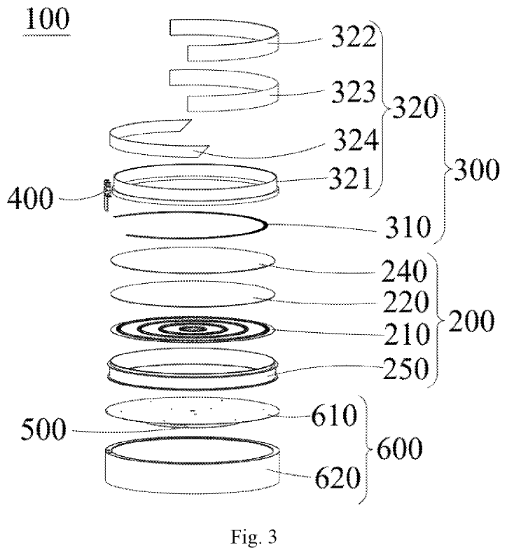

Referring to FIGS. 1-3, a lamp 100 according to an example of the present disclosure includes a first light source system 200, a second light source system 300, and a projection system 400. The first light source system 200 is configured to simulate sunlight at different times of the day in nature. The second light source system 300 is disposed around the outer side of the first light source system 200 and configured to simulate the effect of sunlight illuminating the edge of a skylight. In addition, the second light source system 300 may form a virtual image 303 in the first light source system 200. The projection system 400 is disposed on the side of the second light source system 300 and configured to form light spots on the ground or wall.

The lamp 100 includes a housing 600. The housing 600 includes a bottom wall 610 and a frame 620 extending from the bottom wall 610 in a direction away from the bottom wall 610. A light outlet is formed between the bottom wall 610 and the frame 620. The first light-emitting surface 201 of the first light source system 200 is disposed at the light outlet. The first light source system 200 includes a first light-emitting module 210 and a diffusion structure 220. The first light-emitting module 210 is fixedly connected to the bottom wall 610 and configured to emit light toward the diffusion structure 220. The diffusion structure 220 is mounted in the frame 620, covers the first light-emitting module 210, and is configured to uniformly distribute the light emitted by the first light-emitting module 210.

In an optional example, the first light source system 200 is a ceiling lamp including a base plate, a face mask, and a first light-emitting module 210. The first light-emitting module 210 is a full-spectrum LED chip capable of simulating the solar spectrum. In other examples, the first light-emitting module 210 may also be a conventional white light source. By adding nanoparticles to the diffusion structure 220 of the first light source system 200, Rayleigh scattering is formed, so that the first light-emitting surface 201 presents a blue color like the sky. The present disclosure is not limited thereto.

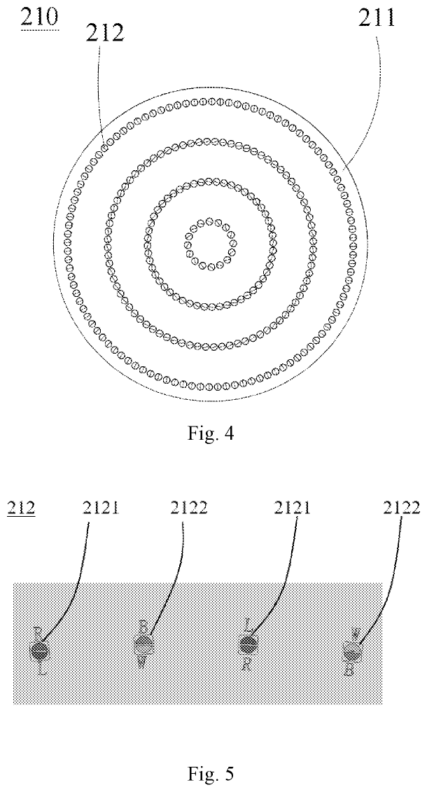

Referring to FIGS. 2-5, in an example of the present disclosure, the first light source system 200 includes a first light-emitting module 210 and a diffusion structure 220. The first light-emitting module 210 includes a first substrate 211 and a plurality of light-emitting modules 212. The first substrate 211 is fixedly connected to the bottom wall 610. The light-emitting modules 212 are mounted on the side of the first substrate 211 away from the bottom wall 610 and electrically connected via the first substrate 211.

Each light-emitting module 212 includes at least two types of light-emitting units capable of emitting light of at least two spectra. The at least two types of light-emitting units are disposed alternately, and adjacent same light-emitting units are disposed upside down.

Referring to FIG. 5, in an example, each light-emitting module 212 in the first light-emitting module 210 includes a first light-emitting unit 2121 and a second light-emitting unit 2122. The first light-emitting unit 2121 and the second light-emitting unit 2122 are disposed alternately, and adjacent first light-emitting units 2121/second light-emitting units 2122 are disposed upside down. The first light-emitting unit 2121 includes any two of four different colored light-emitting elements, and the second light-emitting unit 2122 includes the remaining two colored light-emitting elements. In a single light-emitting module, the disposition from left to right is first light-emitting unit 2121, second light-emitting unit 2122, first light-emitting unit 2121, and second light-emitting unit 2122. The first light-emitting unit 2121 and the second light-emitting unit 2122 are disposed alternately, while adjacent first light-emitting units 2121 or second light-emitting units 2122 are disposed upside down. These four different colored light-emitting elements may achieve different lighting effects. The alternating disposition of different light-emitting units and the upside-down disposition of same light-emitting units make the light emitted by the first light source system 200 more uniform, capable of simulating the color of sunlight at different times and achieving dynamic light effects.

In this example, each light-emitting module includes two first light-emitting units 2121 and two second light-emitting units 2122. In other examples, the count of first light-emitting units 2121 and second light-emitting units 2122 included in the light-emitting module 212 may be more, which is not limited in the present disclosure.

A light source lens (not shown) is sleeved on the light-emitting unit of the light-emitting module. In this example, a light source lens is mounted on each light-emitting unit, i.e., the light source lens corresponds to the light-emitting unit one-to-one. This disposition may concentrate the light emitted by the light-emitting unit to the center of the light source lens before exiting outward, avoiding mutual interference of light. In other examples, the light source lens may also be a two-in-one, four-in-one, or other multi-in-one lens, so that a single light source lens may cover more light-emitting units, or a single lens covering all light-emitting units, which may reduce the count of light source lenses and make production and assembly more convenient and efficient.

In this example, the light-emitting units are disposed in a circular pattern on the first substrate 211. Specifically, they are disposed in multiple concentric circles, and the count of light-emitting units in each circle is a multiple of 6, 7, or 8, and is determined based on the voltage of the light-emitting unit and the voltage of the driving power supply. In this example, the voltage of the lamp bead 422 is 3V, and the voltage of the driving power supply is 24V, so an 8-series connection mode is adopted, i.e., the count of light-emitting units in each concentric circle is a multiple of 8.

In this example, there are Ri circles of light-emitting units on the first substrate 211, where i≥2. The count of light-emitting units in the R1th circle is N, the count in the R2th circle is 2N, and the count in the Rith circle is i*N. Assuming the R1th circle is one string, labeled 1_1, the R2th circle is two strings, labeled 2_1 and 2_2, and so on, the Rith circle is labeled i_1 to i_i, totaling i*(i+1)*(i+2)/6 strings, equivalent to adjusting i*(i+1)*(i+2)/6 beam lines. Since there are four different colored light-emitting elements, the power of light-emitting units in 4i*(i+1)*(i+2)/6 regions may be precisely controlled via the control system to achieve continuous changes in light from morning to night.

In other examples, the light-emitting units may also be disposed in a double-square or other shapes on the first substrate 211, which is not limited in the present disclosure.

The first light source system 200 further includes an inner frame 250 and a diffusion structure 220. The inner frame 250 is sleeved in the frame 720. The diffusion structure 220 is fixedly connected to the end of the inner frame 250 away from the first light-emitting module 210. The light emitted by the light-emitting units in the first light-emitting module 210 passes through the diffusion structure 220, which diffuses the light, converting point or line light sources into uniform surface light sources. In this example, the diffusion structure 220 is a diffusion plate with a transmittance of 40%-65% and a thickness of about 3 mm.

The diffusion plate may effectively eliminate the graininess of the light emitted by the first light-emitting module 210 and has a light diffusion function, i.e., light scatters on its surface, spreading softly and uniformly. After diffusion, the light has a larger irradiation region, good uniformity, and stable chromaticity.

In other examples, the diffusion structure 220 may also be a structural member with micro-structures, and the structural member with micro-structures also covers the light-emitting module, which may also achieve good light uniformity, which is not limited in the present disclosure.

In some examples, the first light source system 200 further includes a transparent plate 240. The transparent plate 240 is fixedly connected to the end of the inner frame 250 away from the first light-emitting module 210 and located on the side of the first light-emitting surface 201 away from the first light-emitting module 210. A side of the transparent plate 240 away from the first light-emitting surface 201 is a mirror surface. At least part of the light emitted by the second light source system 300 exits through the second light-emitting surface 301, projects onto the transparent plate 240, and is reflected by the mirror surface to form a virtual image 303 of the second light-emitting surface 301, simulating the shadow effect formed on a window when sunlight illuminates one side of the window, creating a sense of depth and transparency for the human eye.

The mirror surface of the transparent plate 240 has a higher reflectivity than transmittance for light, thereby limiting external light from entering the transparent plate 240 from the light outlet. Optionally, the transparent plate 240 may be made of an inorganic material such as quartz glass. The transparent plate 240 may also be made of an organic material, and the organic material may be a polymer transparent material, such as plexiglass, which is not limited in the present disclosure.

In some examples, a very thin unidirectional film layer such as tin, silver, or aluminum is plated on the light-emitting surface of the transparent plate 240 by crystal plating process to form a unidirectional film layer. The crystal plating process enables the unidirectional film layer to have high smoothness. In other examples, the transparent plate 240 may be selected according to actual requirements, which is not limited herein. The thickness of the unidirectional film layer may be adjusted according to actual conditions. As the thickness increases, its reflectivity and transmittance change. A unidirectional perspective effect is achieved by using a reflectivity higher than transmittance.

By controlling the brightness changes of light-emitting units in different regions, lighting effects such as morning glow and sunset may be achieved.

The second light source system 300 is detachably connected to the lamp 100, disposed between the frame 620 and the first light source system 200, and surrounds the first light-emitting surface 201 of the first light source system 200. The second light source system 300 extends along the light emission direction of the first light-emitting module 210 and has a second light-emitting surface 301 attached to the side of the frame 620 close to the first light-emitting surface 201. The second light source system 300 further includes a second light-emitting module 310, which is horizontally located between the second light-emitting surface 301 and the frame 620. The light emitted by the second light-emitting module 310 exits through the second light-emitting surface 301 in a direction away from the frame 620. The light emitted from the first light-emitting surface 201 intersects with that from the second light-emitting surface 301, and meanwhile the second light-emitting surface 301 emits light obliquely downward to avoid light from the second light-emitting surface 301 irradiating the non-light-emitting surface 302 of the second light source system 300. The angle between the light emitted from the first light-emitting surface and light emitted from the second light-emitting surface is ≥90°. The light emitting manner of the second-light source system is different from that of conventional ambient lights. The second light source system 300 only emits light toward the inner side of the lamp 100. In this example, the frame 620 is made of an opaque material, creating an effect of sunlight entering and illuminating the windowsill, visually forming a transparent window effect.

In some examples, the second light source system 300 is not additionally provided with a light-emitting module, and the second light-emitting surface 301 is formed by directly reflecting light emitted from the first light-emitting surface 201.

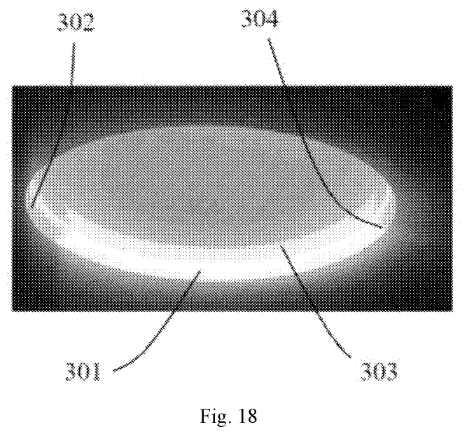

The second light source system 300 further includes a non-light-emitting surface 302, which is also disposed away from the frame 620. A light/shadow transition zone 304 is formed between the non-light-emitting surface 302 and the second light-emitting surface 301. As shown in FIG. 18, this simulates sunlight entering from one side, illuminating one side of the window and forming a dark surface on the other side, making the display effect more realistic. The second light-emitting surface 301 and the non-light-emitting surface 302 are connected in a circumferential direction and jointly form an annular surface surrounding the outer periphery of the first light-emitting surface 201. The function of light/shadow transition zone 304 is to form a light-dark boundary zone between the second light-emitting surface 301 and the non-light-emitting surface 302, which may be a continuous transition zone from bright to dark or a clear boundary line.

The angle between the light emitted from the first light-emitting surface 201 and the light emitted from the second light-emitting surface 301 is ≥90°, which prevents light from the first light-emitting surface 201 from irradiating the non-light-emitting surface 302.

The second light source system 300 includes a second substrate 311 surrounding the first light-emitting surface 201 and a light-emitting element 312 disposed on the second substrate 311. The second substrate 311 includes a light-emitting region close to the second light-emitting surface 301 and a non-light-emitting region away from the second light-emitting surface 301, forming the second light-emitting surface 301 which is illuminated and the non-light-emitting surface 302 which is not illuminated on the outer periphery of the first light-emitting surface 201. The light-emitting element 312 is disposed on the light-emitting region of the second substrate 311, and no light-emitting element is disposed on the non-light-emitting region.

In some examples, the second light source system 300 further includes a light shielding member 324 disposed away from the second light-emitting surface 301. The second light-emitting module 310 and the light shielding member 324 jointly surround the side of the first light-emitting surface 201 close to the frame 620, forming the second light-emitting surface 301 which is illuminated and the non-light-emitting surface 302 which is not illuminated on the outer periphery of the first light-emitting surface 201.

The second light source system 300 may be entirely disposed to rotate relative to the first light source system 200. The second light source system 300 is driven by a micro-motor disposed in the lamp 100, to better simulate the effect of the sun rising in the east and setting in the west.

The second light source system 300 is described below through three examples, which should not be construed as limiting.

### Example I

As shown in FIGS. 2-3 and 6, in this example, the light emission direction of the light-emitting module 310 is the same as that of the first light-emitting module 210. The second light source system 300 includes a light-emitting module 310 and a light guide assembly 320. The light guide assembly 320 includes a light distribution member 322 and a light exit member 321. The light distribution member 322 is disposed below the light-emitting module 310, which emits light toward the light distribution member 322 (i.e., direct downward emission). The light distribution member 322 is configured to refract the light emitted by the light-emitting module 310. The light exit member 321 is disposed on the side of the light distribution member 322 away from the frame 620. After refraction by the light distribution member 322, the light refracted by the light distribution member 322 exits through the light exit member 321 in a direction away from the frame 620. The light distribution member 322 may control the light exit angle, enabling light to exit at a small angle with a long projection distance and stronger transparency.

In some examples, the end of the light exit member 321 away from the first light source system 200 is inclined 5°~30° toward the frame 620, expanding the irradiation range of light from the second light-emitting surface 301.

In this example, the light distribution member 322 is a light guide plate. The light distribution member 322 and the light exit member 321 are made of a transparent optical material, such as PMMA and PC. In other examples, the light distribution member 322 may be optical elements with different structures or other materials, which is not limited in the present disclosure.

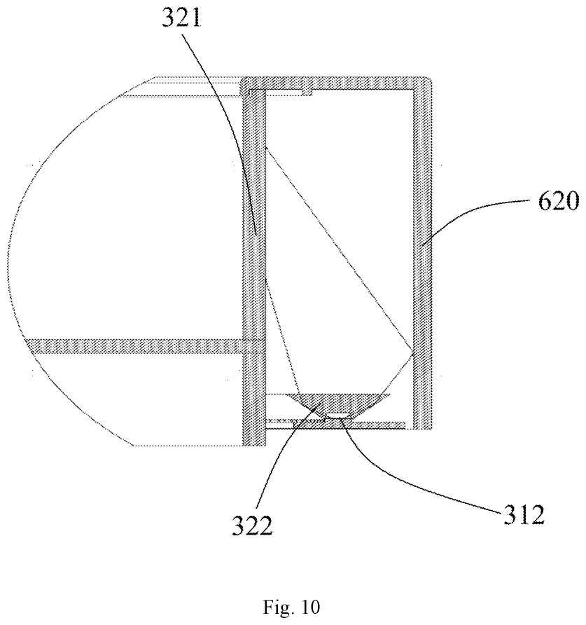

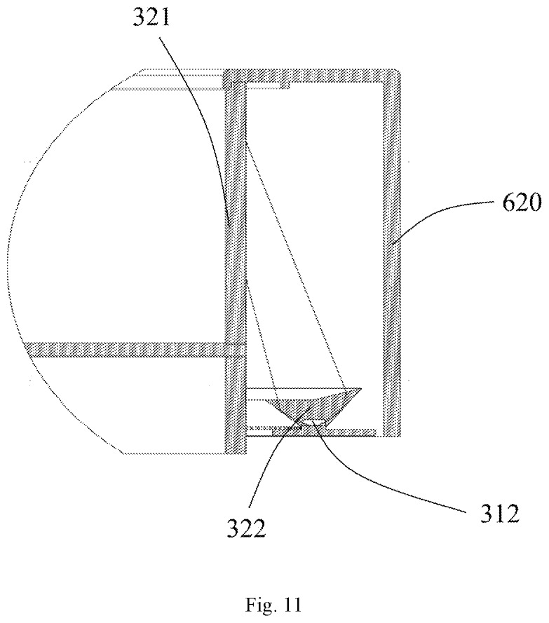

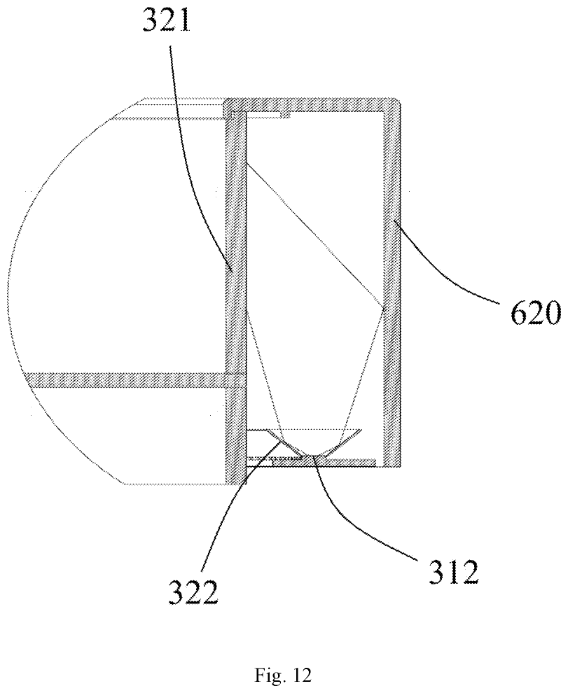

As shown in FIG. 10, in some examples, the light distribution member 322 is a lens. As shown in FIG. 12, in some examples, the light distribution member 322 is a reflector cup. The lens or reflector cup is located in the light emission direction of the light-emitting module 310 and the lens or reflector cup covers the light-emitting element 312. Light emitted by the light-emitting element 312 is refracted by the lens or reflector cup, with part exiting toward the light exit member 321 and part exiting toward the frame 620. A reflector 323 is disposed on the side of the frame 620 close to the light exit member 321 to reflect light toward this part, which then exits toward the light exit member 321.

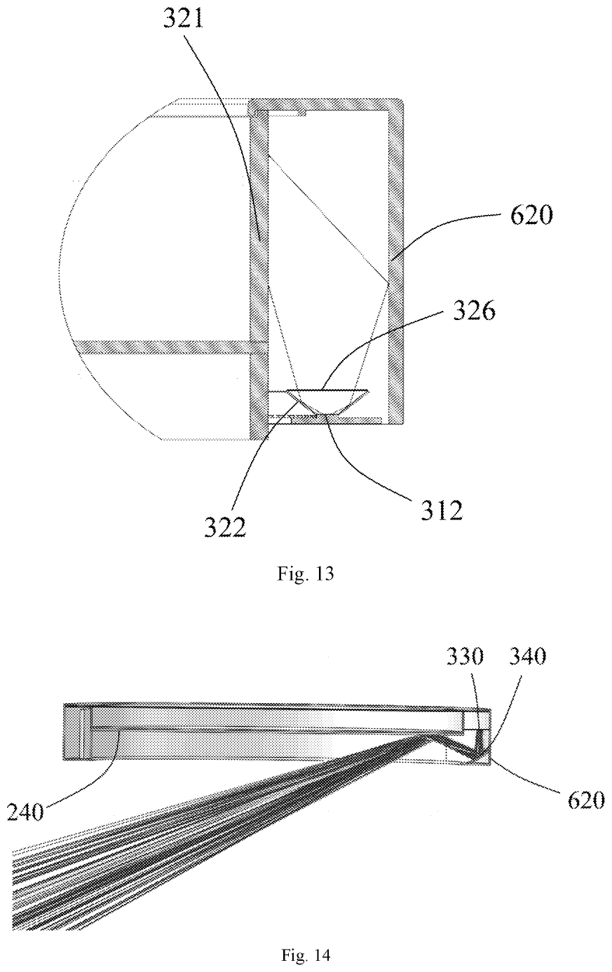

As shown in FIG. 11, in some examples, the light distribution member 322 is an offset lens. As shown in FIG. 13, in some examples, the light distribution member 322 is an eccentric reflector cup. The offset lens or the eccentric reflector cup covers the light-emitting element 312. After light emitted by the light-emitting element 312 is refracted by the offset lens or eccentric reflector cup, all of them is incident on the light exit member 321 towards a direction away from the frame 620. The use of the offset lens and eccentric reflector cup eliminates the need for a reflector 323, simplifying the structure.

As shown in FIG. 12, in some examples, when the light distribution member 322 is a reflector cup, a prism sheet 326 covers the end of the reflector cup away from the light-emitting module 310. The prism sheet 326 is configured to refract part of the light emitted by the light-emitting module 310 that is not refracted by the reflector cup, so that the part of light which has been refracted by the prism sheet exits toward the light exit member 321 or exits towards the reflector 323 on the frame 620, improving the utilization rate of light emitted from the light-emitting module 310.

In other examples, the light emitted by the light-emitting module 310 may also enter the light guide assembly 320 vertically upward, which is not limited in the present disclosure.

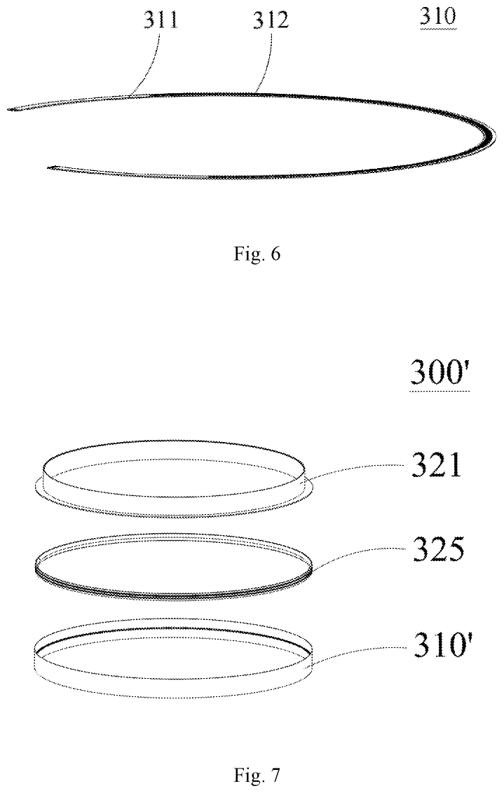

As shown in FIG. 6, the light-emitting module 310 includes a light-emitting substrate 311 and a light-emitting element 312 mounted on a partial region of the light-emitting substrate 311. When the light-emitting element 312 on the light-emitting module 310 emits light outward, the region of the light guide assembly 320 corresponding to the light-emitting elements 312 on the light-emitting substrate 311 is in a bright state (i.e., the second light-emitting surface 301 of the second light source system 300), and the region of the light guide assembly 320 not corresponding to the light-emitting elements 312 is in a dark state (i.e., the non-light-emitting surface 302 of the second light source system 300), simulating the effect of sunlight illuminating an edge of a side of a window when shining into a room through the window.

In other examples, light-emitting elements 312 may be mounted on all regions of the light-emitting substrate 311. By controlling the working state of light-emitting elements 312 in different regions, the conversion between bright region and dark region on the light exit member may be achieved by lighting different positions, simulating the effect of sunlight illuminating the edge of a skylight at different angles at different times of the day, realizing sunrise and sunset. In this example, the frame 620 is made of semi-transparent or transparent material. By controlling colors of light emitted by light-emitting elements 312 in different regions to be different, a rainbow effect may be formed through the frame 620, enhancing the visual experience of the lamp 100.

The light exiting through the light distribution member 322 passes through the light exit member 321, the light exit member 321 can eliminate the graininess of the light emitted by the light-emitting module 310 and meanwhile the light exiting through the light exit member 321 is more uniform.

A reflector 323 is attached to the side of the light distribution member 322 away from the light exit member 321 or the side of the frame 620 close to the light exit member 321 to reflect light emitting toward this region back, so that all light exits in a direction toward the light exit member 321, improving light concentration.

A light shielding member 324 covers the part of the light exit member 321 not covered by the light distribution member 322, preventing light from leaking out from this part of the light exit member 321, ensuring this part of the light exit member 321 is in a dark state, simulating the real effect of sunlight illuminating an edge of a window or skylight.

In other examples, the light shielding member 324 may rotate around the light distribution member 322. When light-emitting elements 312 are mounted on all regions of the light-emitting substrate 311, by rotating the light shielding member 324, a change of the bright region and dark region on the light exit member 321 is implemented.

The height of the light shielding member 324 may be adjusted according to actual conditions by a micro-motor cooperating with a provided elastic member.

### Example II

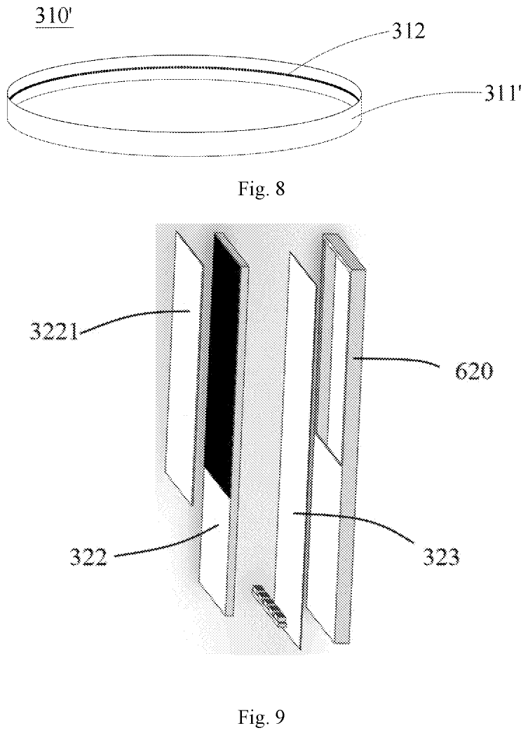

As shown in FIGS. 7-8, in this example, the light emission direction of the light-emitting module 310′ intersects with that of the first light-emitting module 210. The second light source system 300 includes a light exit member 321, disposed between the frame 620 and the light-emitting surface 201, extending along the frame 620 beyond the light-emitting surface 201. The light-emitting module 310′ is disposed on the side of the light exit member 321 facing the frame 620, including an annular light source substrate 311′ and a light-emitting element 312 mounted on the inner side of the substrate. The light-emitting module 310′ emits light in a direction toward the light exit member 321 and the emitted light directly enters the light exit member 321 from the side of light exit member 321.

The second light source system 300′ further includes a light guide lens 325, disposed between the light exit member 321 and the light-emitting module 310′, the light guide lens 325 is connected to the inner side of the light-emitting substrate 311′ and covers the light-emitting element 312. Light emitted by the light-emitting element 312 enters the light incident surface of the light guide lens 325 and is refracted by the light incident surface. The light satisfying Snell's law enters the light guide lens 325, and is refracted at the light exit surface, exiting through the light guide lens 325 and then the light exit member 321, to achieve uniform light emission.

In this example, a flexible printed circuit board (FPC) may be selected as the light-emitting substrate 311′. In other examples, the light-emitting substrate 311 may be other materials.

Preferably, the light exit member 321 is made of transparent optical materials such as PMMA and PC.

In other examples, the light-emitting element 312 may be mounted on all regions of the light-emitting substrate 311′, which is divided into multiple light-emitting regions each including a plurality of light-emitting elements 312. Each region may be controlled independently. By controlling the working state of different regions, the conversion between bright region and dark region on the light exit member 321 is achieved, simulating sunlight illuminating an edge of a skylight at different angles in different times of the day.

In other examples, when light-emitting elements 312 are mounted on all regions of the light-emitting substrate 311′, a light shielding member 324 may be attached to part of the light exit member 321 to prevent light from leaking out from the part of the light exit member 321, making the part of the light exit member 321 to be in dark state and simulating the real effect of sunlight illuminating an edge of a window or an edge of a skylight. The light shielding plate may be rotated, and a change of the bright region of the light exit member 321 is implemented by rotating the light shielding plate to simulate effect of sunrise and sunset.

This example simplifies the overall structure of the second light source system 300. The light-emitting module 310′ surrounds the outer side of the light exit member 321, making assembly convenient and efficient.

### Example III

In this example, the structure of the second light source system 300 is basically the same as that of Example I. The second light source system 300 only emits light toward the side away from the frame 620. The light guide assembly 320 includes a light exit member 321 and a light distribution member 322. The light-emitting module 310 is fixedly connected to one end of the light exit member 321. The light distribution member 322 surrounds the outer side of the light exit member 321, with its upper surface covering the light-emitting elements 312 on the light-emitting module 310. The difference is that micro-structures 3221 are disposed on the second light-emitting surface 301, enabling light to exit at a large angle from the region with micro-structures 3221 on the second light-emitting surface 301.

As shown in FIG. 9, the light distribution member 322 in this example is a light guide plate with micro-structures 3221 disposed on it, the micro-structures 3221 are located on the region of the light distribution member 322 away from the light-emitting module 310. Reverse micro-structures are disposed on the light exit member 321. Light emitted by the light-emitting element 312 destroys total internal reflection via the micro-structures 3221 on the light distribution member 322, so that light exits at a large angle from the region with micro-structures 3221. The light enters the light exit member 321 with reverse micro-structures. By using the reverse micro-structures 3221, part of the light exits at a small angle onto the transparent plate 240, to be reflected to form a transparent virtual image 303.

The angles of the rear surface and light-incident surface of the micro-structures 3221 on the light distribution member 322 are both less than 6°, varying with the distance between the light-emitting element 312 and the light incident side of the light distribution member 322, as well as varying the depth of the V-groove. A light-incident surface angle<6° results in that after the light enter from the incident side, an angle of the light exiting from the light exit surface is 165°~175°. The micro-structures 3221 of the exit side compress the light to be within 30° to a center. The exit light with 165°~175° may exit at a small angle which angle is smaller than 10° by the reverse V-prism on the light exit member 321. Adjusting the angles and depth the V-groove of the light-incident surface and the rear surface may adjust the uniformity of the light exit surface of the light distribution member 322.

Preferably, the angles of the rear surface and light-incident surface of the V-prism in the light distribution member 322 are 0.25°-0.75°, and the apex angle of the reverse V-prism in the light exit member 321 is 55°-70°.

A reflector 323 covers the side of the light distribution member 322 away from the light exit member 321 to reflect light toward this region inside the light distribution member 322, so that all light inside the light distribution member 322 exits in a direction toward the light exit member 321.

As shown in FIG. 14, the lamp 100 further includes a side projection device 330, disposed between the frame 620 and the first light source system 200. The side projection device 330 is configured to project simulated sunlight spots. The simulated sunlight spots projected by the side projection device 330 enter the mirror surface of the transparent plate 240 and are reflected, and exit outward, forming virtual sunlight spots on the first light-emitting surface 201. The human eye may see the scene of sunlight shining down through the transparent plate 240, making the display effect of the lamp 100 more realistic. The virtual image of the first light-emitting surface 201 may be seen by the human eye, making the display effect of the lamp 100 more realistic.

The lamp 100 further includes one or a plurality of reflection devices 340, disposed in the light emission direction of the side projection device 330. Light projected by the side projection device 330 is reflected once or multiple times by the reflection device 340 and then enters the mirror surface of the transparent plate 240. In this example, the reflection device 340 is a reflector, which may be planar, spherical, aspherical, or free-form. When the reflector is a spherical or aspherical reflector, it enlarges or reduces the spot projected by the side projection device 330, while the reflector with free-form not only eliminates aberrations such as distortion and astigmatism, but also adjusts the image distance to make the sun appear more distant, enhancing realism for human eyes.

The side projection device 330 includes a projection lamp bead and a convex lens. The projection lamp bead is a multi-color lamp bead simulating sunlight color temperature at different times. The convex lens is a Fresnel lens or compound eye lens, concentrating light from the projection lamp bead into a uniform spot.

The lamp 100 further includes a projection system 400, disposed between the frame 620 and the second light source system 300, at least partially exposed outside the frame 620. The projection system 400 is configured to project simulated sunlight spots on walls or floors, including circular, elliptical, or quadrilateral spots, similar to projections produced by sunlight passing through the window.

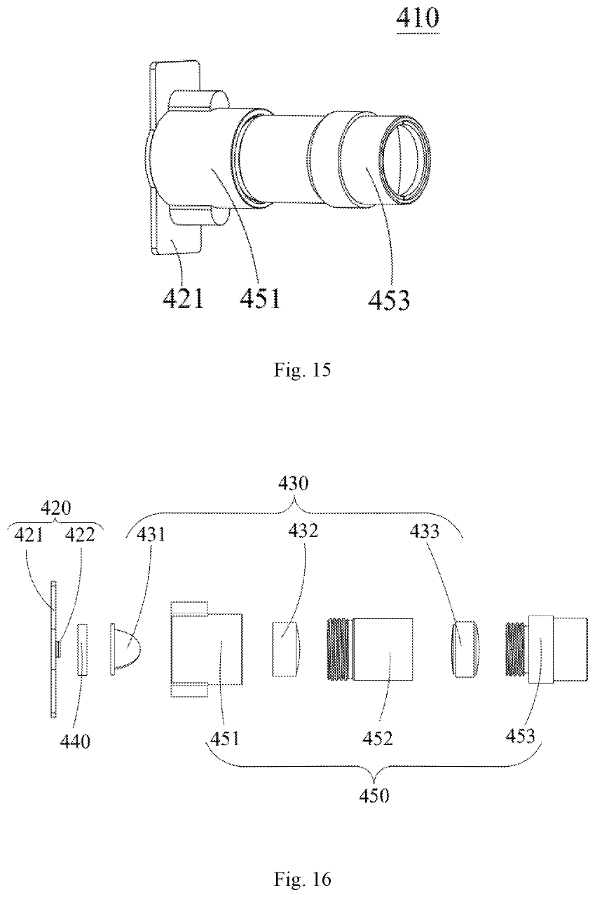

The projection system 400 includes a plurality of projection devices 410. In this example, two projection devices 410 are provided, each movably connected to the frame 620 of the lamp 100 via connectors, and the projection devices 410 is rotatable relative to the frame 620. As shown in FIGS. 15-16, the projection device 410 includes a light-emitting assembly 420, a lens barrel assembly 450, and a lens assembly 430. The light-emitting assembly 420 includes an aluminum substrate 421 and lamp beads 422 mounted on the aluminum substrate 421. A diaphragm 440 is sleeved on the lamp bead 422. The diaphragm 440 is abutting the aluminum substrate 421 and configured to control the intensity and shape of the light beam emitted from the lamp bead 422. A first lens 431 is connected to the end of the diaphragm 440 away from the lamp bead 422. The first lens 431 is configured to form a spot. A first lens barrel 451 is sleeved outside the diaphragm 440 and the first lens 431. A second lens barrel 452 is connected rotatably to the end of the first lens barrel 451 away from the first lens 431, with a second lens 432 embedded on the side close to the first lens barrel 451. A third lens barrel 453 is connected rotatably to the end of the second lens barrel 452 away from the first lens barrel 451, with a third lens 433 embedded on the end away from the second lens barrel 452. The second lens 432 and third lens 433 are configured to image. The first, second, and third lens barrels implement adjusting the focal length.

The first lens 431 and second lens 432 are plastic lenses and the third lens 433 is a glass lens. The plastic lenses have a light weight, and the glass lens can ensure high transmittance.

In this example, the lamp bead 422 is an LED lamp bead, which may be other types in other examples, and it is not limited herein.

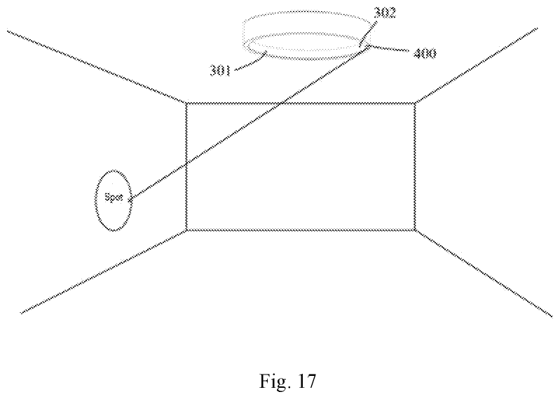

As shown in FIG. 17, the projection direction of the projection system 400 is consistent with the direction of the second light-emitting surface 301, projecting spots on a wall of a side of the part region, simulating projections produced on a wall by real sunlight illumination direction through windows.

The lamp 100 further includes a control system that controls the operation of the first light source system 200, second light source system 300, and projection system 400 to achieve multi-scenario lighting effects.

The mounting system 500 includes a mounting bracket fixedly connected to the bottom wall 610. The lamp 100 is fixedly connected to the mounting surface by the mounting bracket. In this example, the mounting system 500 is a hanger structure, which may be a quick-connect structure in other examples, and it is not limited herein.

In summary, the first light source system 200 of the lamp 100 of the present disclosure may simulate effects such as blue sky, sunset, morning glow, and blue sky with white clouds. The second light source system 300 simulates sunlight illuminating an edge of a window, making the lighting effect of the lamp 100 more realistic. The second light source system 300 may also form a virtual image 303 on the transparent plate 240 provided in the second light source system, creating window shadow effects similar to sunlight illuminating on an edge of a window or a skylight, thus forming spatial sense, depth sense and layering sense. The projection system 400 provides sunlight spots similar to sunlight projected through windows or skylights onto floors or walls, with spot shapes varying with the shape of the whole lamp, achieving multi-scenario applications.

The purpose of the present disclosure is to provide a lamp capable of truly simulating natural light effects.

To achieve the above purpose, the present disclosure provides a lamp, including:
a housing, including a bottom wall and a frame extending from the bottom wall in a direction away from the bottom wall, with a light outlet formed between the bottom wall and the frame;
a first light source system, disposed on the bottom wall and surrounded by the frame, having a first light-emitting surface disposed at the light outlet, the first light source system including a first light-emitting module, and light emitted by the first light-emitting module exiting through the first light-emitting surface;
a second light source system, disposed around the first light-emitting surface of the first light source system, extending along a light emission direction of the first light-emitting module, and having a second light-emitting surface surrounding the first light-emitting surface and located on an inner side of the frame, the second light source system including a second light-emitting module, light emitted by the second light-emitting module exiting through the second light-emitting surface and emitting toward a direction away from the frame, and light emitted from the first light-emitting surface intersecting with light emitted from the second light-emitting surface.

Optionally, the second light source system further includes a non-light-emitting surface disposed away from the frame and adjacent to the second light-emitting surface. The second light-emitting surface and the non-light-emitting surface are connected in a circumferential direction and jointly surrounds the first light-emitting surface to form an annular surface. A light/shadow transition zone is formed between the non-light-emitting surface and the second light-emitting surface.

Optionally, the second light-emitting module includes a second substrate surrounding the first light-emitting surface and a light-emitting element disposed on the second substrate. The light-emitting element has different lighting regions. The second light-emitting surface which is illuminated and the non-light-emitting surface which is not illuminated are formed on an outer periphery of the first light-emitting surface, by controlling the lighting regions on the light-emitting element, including the light-emitting region disposed close to the second light-emitting surface and a non-light-emitting region disposed away from the second light-emitting surface.

Optionally, the second light-emitting module includes a second substrate surrounding the first light-emitting surface and a light-emitting element disposed on a partial region of the second substrate. The second light-emitting surface which is illuminated and the non-light-emitting surface which is not illuminated are formed on an outer periphery of the first light-emitting surface by controlling lighting of the light-emitting element.

Optionally, the second light source system further includes a light shielding member disposed away from the second light-emitting surface. The second light-emitting module and the light shielding member jointly surround a side of the first light-emitting surface close to the frame, so as to form the second light-emitting surface which is illuminated and the non-light-emitting surface which is not illuminated on an outer periphery of the first light-emitting surface.

Optionally, at least part of the light emitted by the second light-emitting module exits through the second light-emitting surface and projects onto the first light-emitting surface to form a virtual image of the second light-emitting surface.

Optionally, the first light source system includes a transparent plate disposed on a side of the first light-emitting surface away from the first light-emitting module. A side of the transparent plate away from the first light-emitting surface is a mirror surface. At least part of the light emitted by the second light-emitting module exits through the second light-emitting surface, projects onto the transparent plate, and is reflected by the mirror surface to form a virtual image of the second light-emitting surface.

Optionally, the light emission direction of the first light-emitting module is the same as the extending direction of the frame. The light emission direction of the second light-emitting module is the same as the light emission direction of the first light-emitting module, or the light emission direction of the second light-emitting module intersects with the light emission direction of the first light-emitting module.

Optionally, the second light source system further includes a light distribution member and a light exit member. The second light-emitting module is disposed above the light distribution member and emits light toward the light distribution member. The light emitted by the second light-emitting module is refracted by the light distribution member and exits through the light exit member in a direction away from the frame.

Optionally, the second light source system further includes a light distribution member and a light exit member. The light distribution member is disposed between the frame and the first light-emitting surface, extends along the extending direction of the frame beyond the first light-emitting surface. The second light-emitting module is disposed on the side of the frame facing the light distribution member and emits light toward the light distribution member. The light emitted by the second light-emitting module is refracted by the light distribution member and exits through the light exit member in a direction away from the frame.

Optionally, the lamp further includes a projection system including at least one projection device. The direction of the exit light-beam of the projection device is consistent with the direction of the second light-emitting surface in the second light source system, so as to form a preset-shaped simulated sunlight spot on a wall or floor in the same direction as the second light-emitting surface.

Optionally, the second light-emitting surface emits light obliquely downward.

Optionally, the light emitted from the first light-emitting surface forms simulated sunlight.

Compared with other implementations, the technical solution of the present disclosure has the following beneficial effects: the first light source system of the lamp of the present disclosure may simulate effects such as blue sky, sunset, morning glow, and blue sky with white clouds, the second light source system surrounding the first light source system may simulate the effect of sunlight entering from one side of a window and illuminating only a windowsill of a side of a window, making the lighting effect of the lamp more realistic.

The present disclosure may include dedicated hardware implementations such as disclosure specific integrated circuits, programmable logic arrays and other hardware devices. The hardware implementations can be constructed to implement one or more of the methods described herein. Examples that may include the apparatus and systems of various implementations can broadly include a variety of electronic and computing systems. One or more examples described herein may implement functions using two or more specific interconnected hardware modules or devices with related control and data signals that can be communicated between and through the modules, or as portions of an disclosure-specific integrated circuit. Accordingly, the system disclosed may encompass software, firmware, and hardware implementations. The terms “module,” “sub-module,” “circuit,” “sub-circuit,” “circuitry,” “sub-circuitry,” “unit,” or “sub-unit” may include memory (shared, dedicated, or group) that stores code or instructions that can be executed by one or more processors. The module refers herein may include one or more circuit with or without stored code or instructions. The module or circuit may include one or more components that are connected.

The above examples are merely illustrative of the technical solutions of the present disclosure and are not intended to be limiting. Although the present disclosure has been described in detail with reference to the examples, those skilled in the art should understand that modifications or equivalent substitutions may be made to the technical solutions of the present disclosure without departing from the spirit and scope of the technical solutions of the present disclosure

1. A lamp, comprising:
a housing, comprising a bottom wall and a frame extending from the bottom wall in a direction away from the bottom wall, with a light outlet formed between the bottom wall and the frame;
a first light source system, disposed on the bottom wall and surrounded by the frame, wherein the first light source system has a first light-emitting surface disposed at the light outlet, the first light source system comprises a first light-emitting module, and light emitted by the first light-emitting module exits through the first light-emitting surface;
a second light source system, disposed around the first light-emitting surface of the first light source system, wherein the second light source system extends along a light emission direction of the first light-emitting module, and has a second light-emitting surface surrounding the first light-emitting surface and located on an inner side of the frame, the second light source system comprises a second light-emitting module, light emitted by the second light-emitting module exits through the second light-emitting surface and emits towards a direction away from the frame, and light emitted from the first light-emitting surface intersects with light emitted from the second light-emitting surface.

2. The lamp according to claim 1, wherein the second light source system further comprises a non-light-emitting surface disposed away from the frame and adjacent to the second light-emitting surface, wherein the second light-emitting surface and the non-light-emitting surface are connected in a circumferential direction and surround the first light-emitting surface to form an annular surface, and a light/shadow transition zone is formed between the non-light-emitting surface and the second light-emitting surface.

3. The lamp according to claim 2, wherein the second light-emitting module comprises a second substrate surrounding the first light-emitting surface and a light-emitting element disposed on the second substrate, the light-emitting element has different lighting regions, the second light-emitting surface which is illuminated and the non-light-emitting surface which is not illuminated are formed on an outer periphery of the first light-emitting surface by controlling the lighting regions on the light-emitting element.

4. The lamp according to claim 2, wherein the second light-emitting module comprises a second substrate surrounding the first light-emitting surface and a light-emitting element disposed on a partial region of the second substrate, and the second light-emitting surface which is illuminated and the non-light-emitting surface which is not illuminated are formed on an outer periphery of the first light-emitting surface by controlling lighting of the light-emitting element.

5. The lamp according to claim 2, wherein the second light source system further comprises a light shielding member disposed away from the second light-emitting surface, the second light-emitting module and the light shielding member jointly surround a side of the first light-emitting surface close to the frame, so as to form the second light-emitting surface which is illuminated and the non-light-emitting surface which is not illuminated on an outer periphery of the first light-emitting surface.

6. The lamp according to claim 2, wherein at least part of the light emitted by the second light-emitting module exits through the second light-emitting surface and projects onto the first light-emitting surface to form a virtual image of the second light-emitting surface.

7. The lamp according to claim 5, wherein the first light source system comprises a transparent plate disposed on a side of the first light-emitting surface away from the first light-emitting module, a side of the transparent plate away from the first light-emitting surface is a mirror surface, at least part of the light emitted by the second light-emitting module exits through the second light-emitting surface and projects onto the transparent plate, and is reflected by the mirror surface to form a virtual image of the second light-emitting surface.

8. The lamp according to claim 1, wherein the light emission direction of the first light-emitting module is the same as an extending direction of the frame, and a light emission direction of the second light-emitting module is the same as or intersects with the light emission direction of the first light-emitting module.

9. The lamp according to claim 1, wherein the second light source system further comprises a light distribution member and a light exit member, the second light-emitting module is disposed above the light distribution member and emits light toward the light distribution member, the light emitted by the second light-emitting module is refracted by the light distribution member and exits through the light exit member in a direction away from the frame.

10. The lamp according to claim 1, wherein the second light source system further comprises a light distribution member and a light exit member, the light distribution member is disposed between the frame and the first light-emitting surface, and extends along an extending direction of the frame beyond the first light-emitting surface, the second light-emitting module is disposed on a side of the frame facing the light distribution member and emits light toward the light distribution member, the light emitted by the second light-emitting module is refracted by the light distribution member and exits through the light exit member in a direction away from the frame.

11. The lamp according to claim 1, wherein the lamp further comprises a projection system, the projection system comprises at least one projection device, a direction of an exit light-beam of the projection device is consistent with a direction of the second light-emitting surface in the second light source system, so as to form a preset-shaped simulated sunlight spot on a wall or floor in the same direction as the second light-emitting surface.

12. The lamp according to claim 1, wherein the second light-emitting surface emits light obliquely downward.

13. The lamp according to claim 1, wherein the light emitted from the first light-emitting surface forms simulated sunlight.
